(19) United States
(12) Patent Application Publication
(10) Pub. No.: US 2007/0286770 A1
(43) Pub. Date: Dec. 13, 2007

(54) Laboratory Reagent and Sample Assembly, Management and Processing

(75) Inventors: Gary P. Magnant, Topsfield, MA (US); William Bowers, Ipswich, MA (US); Todd J. Barbera, Marblehead, MA (US)

Correspondence Address: BROMBERG & SUNSTEIN LLP, 125 SUMMER STREET, BOSTON, MA, 02110-1618, US

(73) Assignee: SAGE SCIENCE, INC., Beverly, MA (US)

(21) Appl. No.: 11/685,557

(22) Filed: Mar. 13, 2007

Related U.S. Application Data
(60) Provisional application No. 60/781,895, filed on Mar. 13, 2006.
(60) Provisional application No. 60/791,390, filed on Apr. 12, 2006.
(60) Provisional application No. 60/798,917, filed on May 9, 2006.
(60) Provisional application No. 60/799,746, filed on May 11, 2006.
(60) Provisional application No. 60/890,689, filed on Feb. 20, 2007.

(51) Int. Cl. G01N 21/01; B01L 11/00

(52) U.S. Cl. 422/55; 29/592; 422/61

(57) ABSTRACT

A fluid handling apparatus for use with a fluid transfer instrument has a support member for supporting a receptacle having a plurality of wells (each well has an opening defining a well plane), and at least one detector operatively coupled with the support member. The detector detects when an instrument penetrates the well plane of at least one of the plurality of wells.

### CROSS REFERENCE TO RELATED APPLICATIONS

This application claims priority from the following U.S. Provisional Patent Applications, all of which are hereby incorporated herein by reference in their entireties:

Ser. No. 60/781,895 for “Fluid Receiving Member Instrumentation and Method” filed Mar. 13, 2006 (Attorney Docket No. 3094/102);

Ser. No. 60/791,390 for “Fluid Receiving Member Instrumentation and Method B” filed Apr. 12, 2006 (Attorney Docket No. 3094/104);

Ser. No. 60/798,917 for “Fluid Receiving Member Instrumentation and Method” filed May 9, 2006 (Attorney Docket No. 3094/105);

Ser. No. 60/799,746 for “Fluid Receiving Member Instrumentation and Method” filed May 11, 2006 (Attorney Docket No. 3094/107); and

Ser. No. 60/890,689 for “Intelligent Laboratory Benchtop System” filed Feb. 20, 2007 (Attorney Docket No. 3094/112).

### TECHNICAL FIELD

The invention generally relates to laboratory sample and reagent handling instrumentation and, more particularly, the invention relates to storing and packaging samples and reagents, as well as detecting, guiding, communicating, and transferring of sample and reagents.

### BACKGROUND ART

Scientists and technicians use a wide variety of instruments to produce chemical reactions in the laboratory. For example, a laboratory technician may produce a chemical reaction by dispensing reagents into one or more wells of a conventional microliter plate. More specifically, as known by those skilled in the art, a microliter plate typically has a flat portion with a two-dimensional array of independent wells that each form individual test tubes. Each well is capable of producing separate and distinct chemical reactions. One widely used type of microliter plate has an 8×12 array of equally spaced wells. Accordingly, a lab technician may produce 96 separate chemical reactions in a single 8×12 microliter plate.

Problems often arise, however, when the scientist, technician, or other laboratory personnel inadvertently dispenses fluid into the wrong well of a microliter plate, or dispenses fluid at the wrong time. Among other undesirable results, these types of human error (or machine error in an automated process) can produce incorrect test results, waste time and resources, and increase the overall cost of the experiment.

Additionally, assembly of reagents prior to performing an experimental protocol is time consuming and may lead to undesirably inconsistent environmental histories of the reagents.

As our knowledge of chemistry and biology expand, our youth face an increasingly greater science education challenges. Teaching laboratory science to our youth is cumbersome activity, due in part to the complexity of assembly reagents, equipment, and lesson plans. Technology to lower that burden would be of great use.

### SUMMARY OF THE INVENTION

In accordance with an illustrative embodiment, a laboratory assistant system has one or more packaged reagents for performing a laboratory procedure, set of machine readable instructions corresponding to a set of manual region handling steps for executing the procedure, and the computer that is adapted to accept the instructions, to accept information related to region handling stats previously executed by an experimentalist, and adapted to communicate to the experimentalist information based on the instructions for a step yet be executed.

The procedure may be one of a biological, chemical, biochemical, diagnostic and molecular biological procedure. The system may include a set of machine readable instructions obtained from a source selected from the group consisting of a machine readable media, a pointer to instructions available over a network, and a pointer to instructions available on computer media. The information related to steps previously executed by the experimentalist may be obtained using least one sensor that is adapted to detect threshold proximity of a liquid dispensing device with respect to a given receptacle within a set of receptacles. The threshold proximity may be determined by measuring occlusion of a light beam. The threshold proximity may be further correlated using an additional parameter such as occlusion of a light beam or actuation of a liquid dispenser. The sensor may transfer a value related to the position of the given receptacle to the computer and the computer may record the position value in association with a clock reading indicative of to the time of sensing the threshold proximity. The system may also include an analytical device adapted to measure a property of the given receptacle and to use the clock reading associated with the receptacle to determine a one of a reaction rate and an extent of reaction. The analytical device may be an optical microplate reader and the receptacles may be wells of a microplate.

The computer may communicate to the experimentalist via a media selected from the group consisting of audible speech, instructions on a display, and microplate well associated visible indicia. The computer may communicate a warning.

In a related embodiment, there is a method for manufacturing a reagent kit. The method includes the steps of: packaging at least one reagent, generating a protocol script readable by a computer so as to generate instructions for a plurality of protocol steps for communicating to an experimentalist an instruction for a first protocol step, awaiting detection of a liquid handling action initiated by the experimentalist and communicating to the experimentalist a second instruction for a second protocol step; associating the protocol script with the reagent; and shipping the reagent to one of a customer and a distributor.

In another embodiment, there is a microplate reader. The reader has a support member for positioning a microplate with an array of receptacles. The reader also has an array of optical detectors positioned to detect light emanating from the receptacles. A proximity threshold sensor is adapted to detect a threshold proximity of a liquid handling instrument relative to a given receptacle so as to identify the microplate location of the given well. A computer is adapted to associate and store data related to the optical detectors with a sensor signal given receptacle.

In related embodiments, the microplate reader may have a plurality of sensors. The reader may also have at least one optical emitter that is adapted to emit light so as to excite fluorescent transitions in a sample held within the receptacles. The reader may also include a clock and the computer may use the clock to associate a time with a threshold proximity signal. The microplate reader may also include a temperature control system. The computer may use a protocol script to communicate instructions to a user based on a pattern of threshold proximity signals.

### BRIEF DESCRIPTION OF THE DRAWINGS

The foregoing advantages of the invention will be appreciated more fully from the following further description thereof with reference to the accompanying drawings. Below is a brief description of the drawings.

FIG. 1 schematically shows a perspective, partially cut-away view of fluid mixing apparatus and system configured in accordance with illustrative embodiments of the invention.

FIG. 2 schematically shows a plan view of the fluid mixing apparatus and system shown in FIG. 1.

FIG. 3 schematically shows a method of using the fluid mixing apparatus and system shown in FIG. 1.

FIG. 4 schematically shows a plan view of the fluid mixing apparatus and system of FIG. 1 illuminating a first set of wells.

FIG. 5 schematically shows a plan view of the fluid mixing apparatus and system of FIG. 1 illuminating a second set of wells.

FIG. 6 schematically shows a perspective view of an alternative system for mixing fluids having an external display device.

FIG. 7 schematically shows another alternative system for mixing fluids having two systems that each have a support member and receptacle.

### DESCRIPTION OF ILLUSTRATIVE EMBODIMENTS

In illustrative embodiments, a fluid handling system detects when a fluid transfer apparatus (e.g., a pipette) is positioned to transfer fluid to or from the well of a receptacle (e.g., a microliter plate) it supports. Detecting the fluid transfer apparatus in this manner consequently enables a variety of other useful functionalities. Among others, the fluid handling system may responsively guide the user through a complete dispensing process, record actual results of the process, and elicit an audible or visual alarm if the user attempts to transfer fluid to or from the wrong well. Details of this and other embodiments are discussed below.

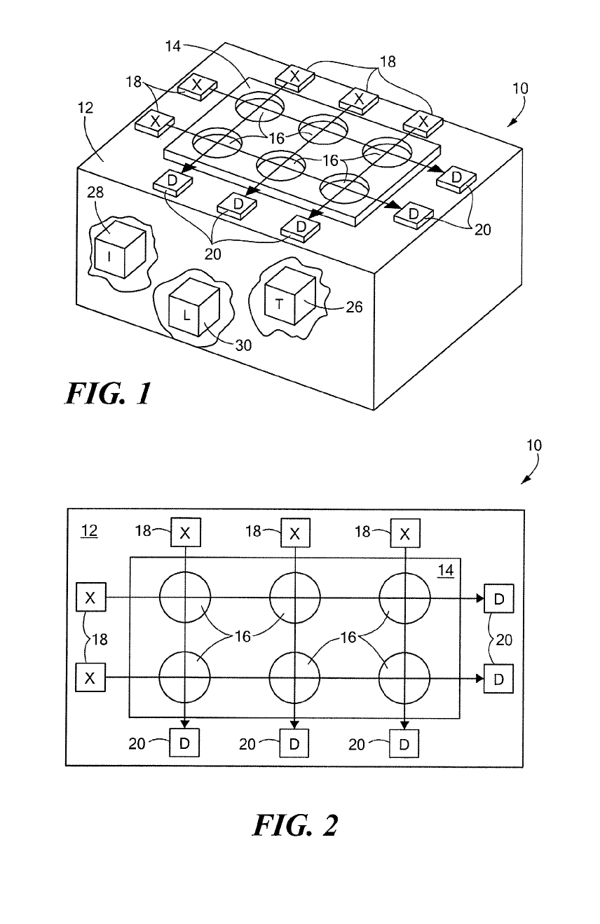

FIG. 1 schematically shows a perspective, partially cut-away view of a fluid mixing apparatus/system 10 (hereinafter “system 10”) configured in accordance with illustrative embodiments of the invention. FIG. 2 schematically shows a plan view of the same system 10. The system 10 includes a support member 12 configured to support a receptacle 14 having a plurality of wells 16. The support member 12 may be configured to have a central recess that receives the receptacle 14. In accordance with illustrative embodiments, the support member 12 also has detection components for detecting access of a supported receptacle 14 (discussed in detail below).

The receptacle 14 may be a microliter plate (also identified herein by reference number 14) having a plurality of wells 16. Although only six wells 16 are shown (a 3×2 array), various aspects of the invention apply to use with microtiter plates having fewer or more wells 16. For example, the microtiter plate 14 can have a single well, 24 wells, 96 wells, 384 wells, or up to 1536 wells, or more wells. In illustrative embodiments, the microliter plate 14 used with the described support member 12 is a standard, off the shelf component having 12 columns and 8 rows of wells 16. Although not discussed below, in an alternative embodiment, the plates 14 are not standard. Instead, such plates 14 have integrated detection components.

For simplicity, this discussion refers to the receptacle 14 as a conventional 3 column, 2 row microliter plate 14. It should be noted, however, that discussion of the receptacle 14 as a microliter plate 14 is for illustrative purposes and thus, is not intended to limit all embodiments of the invention. Accordingly, those skilled in the art should understand that other receptacles 12 can be used, such as single or multiple microfuge tube(s), trough(s), or test tube(s).

As noted above, the support member 12 has a plurality of detectors that detect the presence of a fluid dispensing apparatus (e.g., a pipette) when such apparatus is in a prespecified position for adding fluid to, or withdrawing from, any of the wells 16. To that end, the support member 12 of FIG. 1 has one row of three light emitting diodes 18 (transmitters), and one row of three corresponding light detectors 20. In a like manner, the support member 12 also has one column of two light emitting diodes 18, and one column of two corresponding light detectors 20. Each light emitting diode 18 generates a light beam that is directed in a substantially straight line toward its corresponding detector 20. Accordingly, because the diodes 18 and detectors 20 are arranged in an array format, each well 16 of a supported receptacle 14 has two substantially orthogonal light beams positioned in relatively close proximity to its opening. As discussed below, these two orthogonal light beams effectively form a cross-hair preferably having a center substantially at the center of each well opening.

In some embodiments, the support member 12 is preconfigured so that it can accept only a specific type of receptacle 14, such as a standard 8×12 microliter plate. Accordingly, the diodes 18 and detectors 20 are pre-positioned to produce an array of cross-hairs 24 that, as shown in the figures, align with the array of well openings of that specific plate 14. In fact, the diodes 18 form these cross-hairs even when the support member 12 does not support the plate 14. The support member 12 therefore also preferably has some kind of securing apparatus (not shown) that precisely positions the supported plate 14 to ensure proper alignment with the cross-hairs 24. In alternative embodiments, however, the detectors 20 are movable to accommodate varying sized receptacles. The support member 12 is generally made for use with a microplate 14 having a maximum rated size. In such case, the support member 12 can be used with receptacles 14 having fewer wells 16. For example, a 96 well plate 14 may be used with a support member 12 designed to also accept a 384 well plate 12.

Some embodiments can use motion or other proximity detecting technology other than the diodes 18 and detectors 20 shown in FIG. 1. For example, each well 16 may have a single motion detecting device. In other embodiments, the light sources 18 may be laser diodes or infrared lasers. For embodiments in which each light source contributes to cross-hairs above multiple wells, lasers have an advantage of being highly collimated. Accordingly, in that case, the cross-hairs are formed from beams of approximately uniform width throughout the illuminated plane. Non-coherent light sources, including light emitting diodes 18, may be coupled with collimating optics to improve their performance.

To increase reliability, redundant light sources and detectors 20 also may be used. For example, the system may have cross-hairs in two or more parallel planes, or in side-by-side arrangement. A system having redundant cross-hairs may advantageously have the diodes 18 and detectors 20 in an alternating configuration to compensate for sub-optimal light collimation. If the redundant cross-hairs are in two parallel planes, then the system may be configured to recognize a dispensing event only if both cross-hairs above a given well are disrupted. Of course, the detectors 20 use corresponding detecting technology suitable to detect the illuminating wavelength and intensity.

Some embodiments integrate a visual display (not shown) into the support member 12 to provide additional instructions and data (e.g., data showing the volume of liquid to be added or removed) in real-time. Moreover, as discussed above, the support member 12 also may contain a number of other functional elements that cooperate with the wells 16 of the receptacle 14, and the diodes 18 and detectors 20. Those functional elements (shown in a cut-away portion of the support member 12 in FIG. 1) include a temperature module 26 for controlling the temperature within the wells 16 of a supported receptacle 14, and an imaging apparatus 28 for capturing optical properties, such as UV/visible absorbance, fluorescence, or luminescence of samples within each well 16. The functional elements also include a logic module 30 for coordinating, among other things, the diodes 18, detectors 20, imaging apparatus 28, and temperature module 26. The logic module 30 also may coordinate with external components, such as external computers and memory. In alternative embodiments, the logic module 30 is an external computer system, server, or other similar logic device. Details of the interaction of these functional elements is described in greater detail below.

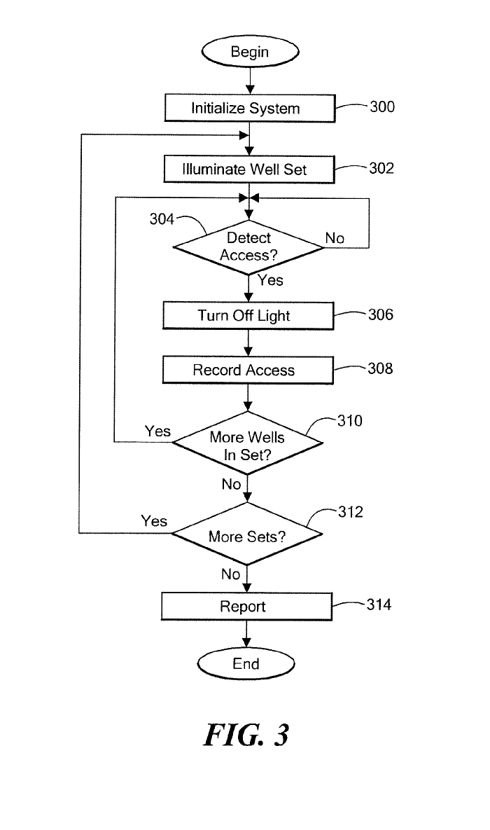

FIG. 3 schematically shows a method of assisting the fluid mixing process in the system shown in FIG. 1. The process begins at step 300, which initializes the system. To that end, among other things, a user may place a receptacle 14 (e.g., a microliter plate) on the support member 12 before, during, or after the logic module 30 begins its initialization processes. Specifically, among other things, the logic module 30 may initialize the system 10 by energizing the light emitting diodes 18 and detectors 20, and initializing communication with external devices, such as a computer and memory device. The logic module 30 also may control a graphical user-interface for controlling other functional elements, such as the temperature module 26 and imaging apparatus 28. Alternatively, the logic module 30 may be preprogrammed to control the imaging apparatus 28 and temperature module 26 in accordance with a prescribed set of instructions. In addition, the logic module 30 may create a record in memory for storing details of the mixing process, and assign wells 16 to a plurality of different well sets (discussed below).

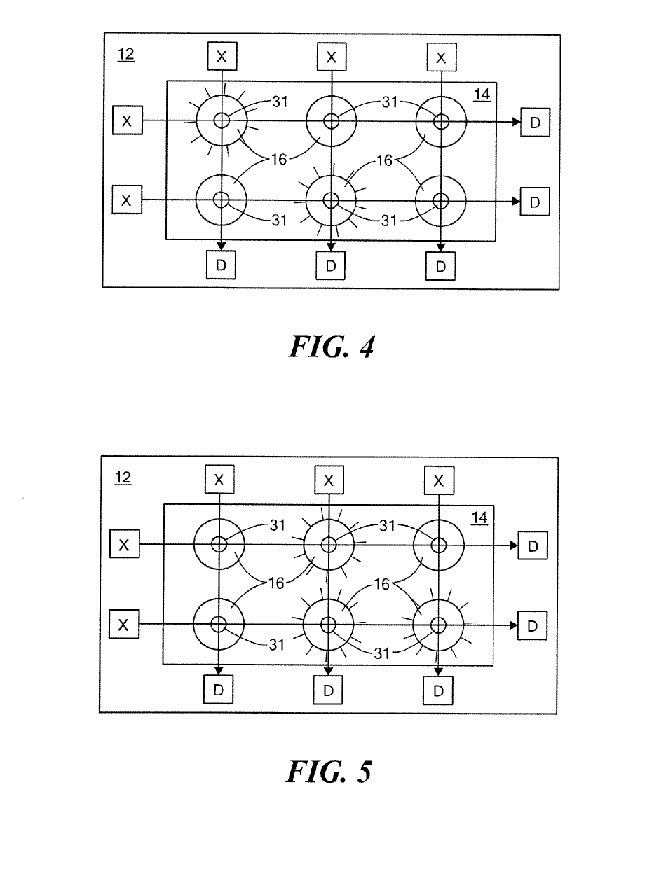

The process then continues to step 302, which illuminates a first set of wells 16 (i.e., a prescribed group having between zero to six wells 16). To that end, each well 16 in the microliter plate 14 shown in FIG. 1 has an associated light element 31 that may be selectively illuminated for a specific purpose (see FIG. 4). For example, the light elements 31 of the top left and bottom center wells 16 of FIG. 4 are illuminated.

The meaning assigned to an illuminated well 16 may vary depending upon application. For example, an illuminated well 16 may indicate that the reaction in that well 16 is complete, or that a reagent should be removed from that well 16. As another example, an illuminated well 16 may serve as a visual indicia that the user should add a reagent to that particular well 16. FIG. 3 continues by discussing the latter example. In some embodiments, illumination of a set of wells may be accompanied by real-time instructions displayed on an associated display device. The instructions may indicate the type and volume of reagent to be added or removed from one or more wells 16.

The light elements 31 for each well 16 may be any of a variety of colors. For example, a red light may indicate that the reaction is complete, while a green light to indicate that reagent should be added. Accordingly, a single light element may be capable of emitting multiple colors, or comprise multiple different light elements having different qualities. Visual indicia also may be provided to indicate whether a volume is to be added or removed during a particular fluid handling step. Additional qualities of the emitted light can be modified, such as the intensity of the light, and whether the light element 31 is blinking. By combining 2 differently colored light sources and cyclically flashing them on and off for controlled periods of time at a cycle frequency that is faster than can be perceived by the human eye, additional colors may be simulated. For example relatively inexpensive red and green LEDs may be used as light elements 31; by alternately flashing them at a frequency of greater than about 10 Hz, simulated yellow or orange colors may appear. Colors may be varied by altering the relative on-time for each LED in the cycle. Similarly, using three colors of LEDs can enable an even broader range of colors.

To that end, in illustrative embodiments, an LED control can use 3-state CMOS drivers with a VDD of, for example, 5 volts. In fact, among other ways, all LEDs can be independently controllable, using a single output line per LED, as follows:

Red/Green LEDs coupled in antiparallel (e.g., on a single device), with one leg connected through a resistor to a rail near 2.5 volts, and the other leg connected to a 3-state output. If the output is five volts, it is red, if zero volts, it is green, 3-state is off, and various square waves give different colors. The 2.5 volt rail actually may be adjusted to a voltage that will equalize the intensity of red and green.

After the first set of well light elements 31 are illuminated, the process determines if the user has accessed any of the wells 16 (step 304). To that end, the process determines if any of the light beams have experienced any mechanical interference. Specifically, if the user positions a pipette near the opening of a well 16, it may intersect substantially with the associated well cross-hair. At this point in the process, the user may dispense or withdraw fluid from the well 16 in a conventional manner. If the pipette is not positioned close enough to the well opening, however, fluid ejected from the pipette may necessarily intersect the cross-hair, thus providing the requisite detection function.

Interference with the signal may be manifested in the form of a voltage or other signal from the appropriate row and column detectors 20. The associated row and column detector pair thus transmit such signals to the logic module 30 indicating that something has interfered with their respective received light signals. Although a number of mechanical objects can break a light beam, it is recommended that users ensure that only a pipette or other fluid transfer apparatus does, in fact, break the light beam. To reduce the chance of a spurious triggering decision, additional correlative data may be incorporated into the decision; for example, triggering sensitivity may be temporarily increased around the time that a pipetting step is detected, or when a RFID tag affixed to a pipetting instrument's is detected by the support member 12. A second, redundant light beam would also enable accurate detection of the angle of pipettor tips and thereby allow for accurate prediction of well location if the pipettor tip enters at an angle.

In the event that a user inadvertently triggers one or more detectors 20, an over-ride routine may be provided to allow normal operation to resume. The over-ride may be logged by the computer for attachment to the data set. In any event, it is important for the cross-hair to be substantially concentrically positioned over the center of the well opening. Although not optimal, however, off-center cross-hairs 24 still should suffice in many instances. In some instances, the beams may be more rectilinear creating a plane of detection over the wells. When a pipette tip crosses the plane, a signal drop may be recorded in that region of the plate, thus identifying the appropriate well.

In a similar manner, illustrative embodiments position the cross-hair a very small distance above the plane of the well opening. For example, empirical tests may show approximate distances that users position a pipette from the opening when transferring fluid into or from a well 16. The cross-hair therefore may be positioned substantially at that height, or some distance slightly above that height. Care should be taken that the cross-hairs not be positioned so close to the well openings that normal variation or warping of microplates 14 will break the light beams. In some embodiments, however, the two substantially perpendicular beams forming a cross-hair do not physically intersect. Specifically, in that case, the beams may be on separate planes and thus, not directly interfere.

The detectors 20 are considered to detect when an instrument penetrates/accesses the plane of a specific well opening (i.e., the plane formed by the well opening) if it detects interference of the cross-hair associated with that well 16. Such interference may be any change in the integrity of the cross-hair. For example, such interference could be a direct blocking of the beam, or simply a reduction in light intensity.

After it detects penetration/access in the first well 16 and determines that such well 16 is in the first set, the logic module 30 turns off the light associated with the first well 16 (step 306). In alternative embodiments, the light element 31 may or remain on, change color, or blink at some prescribed frequency. The logic module 30 may sound an alarm if the well 16 is not in the first set.

The process then continues to step 308, in which the logic module 30 records the date and time of access of the specific well 16 just accessed. As suggested above, this record could be maintained in a local memory device, or transmitted externally, such as by a wired or wireless connection, to an external memory device. The memory device may include either or both volatile or nonvolatile memory, such as a hard disk drive or disk array implementing a fault tolerant memory protocol (e.g., RAID).

Among other things, the record may be associated with an experimental data set in a laboratory information management system (LIMS). A bar code or RF ID reader also may be incorporated into the system 10 to assist in tracking the data. Of course, the logic module 30 may also cause recordal of data other than well penetration data. For example, the logic module 30 may record environmental conditions, such as microliter plate temperature. When operated in conjunction with an instrumented liquid dispenser, such as liquid handling robot or semi-manual instrumented pipette (discussed in more detail below), the system 10 may record the volume setting of the dispensing instrument. These various records may be useful in confirming the accuracy of a procedure for various reasons, including scientific and forensic purposes (e.g., use as evidence in a criminal trial). The logic module 30 also may record the time or times at which reactions were started or stopped in multiple wells. The start times may then be subtracted from the times at which a reaction was stopped or analyzed to compute a reaction rate.

Step 310 then determines if the set of wells 16 currently being processed has more lit, unaccessed wells 16. If the set has more lit, unaccessed wells 16, then the process loops back to step 304 to monitor the other wells 16. Conversely, if step 310 determines that the set has no additional lit, unaccessed wells 16, then the process continues to step 312, which determines if the process has any more sets of wells 16 to be processed.

If there are additional sets to be processed, the process loops back to 302, which illuminates the next set of wells 16. FIG. 5 schematically shows a second set of wells 16 of the same microliter plate 14 that may be processed as discussed. It should be noted that the second set has a different number of wells 16 than that of the first set, while both sets share a common well 16. Of course, both sets could have no common wells 16, or all common wells 16.

Returning to step 312, if there are no additional sets to be processed, then the process continues to step 314, which generates a report summarizing the actual steps (i.e., well accesses) taken by the user. This report may be either hard copy or computer copy, and may be used as a concrete record of the entire experiment.

It should be noted that application of the well detecting technology discussed in FIG. 3 is illustrative. Other processes may be used, such as a simple detecting and recording process that does not illuminate the wells 16 (e.g., creating a record or protocol of the experiment), or a process that simply illuminates one well 16 at a time (i.e., each set having one well 16 only). As another example, the process simply may responsively illuminate the wells 16 on a column by column basis, or on a row by row basis.

As noted, the process of FIG. 3 may be modified to also alert the user when a well 16 has been erroneously accessed. To that end, when a pipette breaks the cross-hair of a well 16 that is not in the set currently being processed, the logic module 30 may generate an error message on a user interface, or actuate an audible alarm signal. As suggested above, this modified process may be used with or without lighting wells 16 in the set, and/or without recording the results. It nevertheless is preferred that the logic module 30 record all results, whether or not they indicate erroneous well accesses.

An embodiment of the invention further increases laboratory worker productivity and increases the probability of a successful experiment. After recording a start-time, the logic-module 30 may start a timer and trigger one or more alarms after a preset elapsed time to remind a user to perform an additional step, such as adding an additional reagent to particular wells 16, or recording the results of a reaction with a microplate reader; a user can thus more readily perform additional tasks during incubation steps without the risk of forgetting about the reaction occurring in the wells 16. The alarm can be any of a variety of audible or visual signals, a vibration, a computer generated or processed voice, an email, page, text message or any of a variety of other suitable signals. The message may be nonspecific (e.g., a loud beep), or give specific details such as how much of a particular reagent to add at a specific time. For example, a computer generated voice may announce “Alert: add ten microliters of one molar sodium hydroxide to plate number one in three minutes.” Repeat reminders may be provided and the system 10 may include a snooze feature to defer future reminders for a given period of time.

The temperature module 26 and imaging apparatus 28 may be used before, during, or after the process of FIG. 3, and have the functionality of a temperature-controlled optical microplate reader. For example, the imaging apparatus 28 may acquire optical information, such as the fluorescently measured reaction progress of a sample in a given well 16 before and after a reagent is added. In some embodiments having an imaging apparatus 28, the light elements 31 can function not only as visual signals to a user, but to excite fluorescent transitions of molecules in the wells 16 for quantitative or qualitative analytical purposes. If used as excitation elements, the light elements 31 may be equipped with filters to reduce stray light, and/or to allow fluorescently multiplexed assays. Detection components may be placed under the wells 16 or over the wells 16 (e.g., the system 10 could be placed under an array of photodetectors such as a CCD array). In an illustrative application, the imaging apparatus 28 may be used to determine the quantity of DNA in each well 16 if the DNA is bound to a fluorogenic reporting reagent such as SYBR Green (Invitrogen Corporation, Carlsbad, Calif.); the presence or absence of the proper amount of DNA may be communicated to a user during or after completion of the procedure.

The temperature module 26 may keep a reagent or mixture of reagents cool (e.g. to 4° C.) to prevent unwanted reactions. Upon detecting that a start reagent has been added to all of the desired wells, the temperature module 26 may automatically increase the temperature to some desired temperature (e.g. to 37° C.). Each optical data point may be transferred electronically to an external computer system for subsequent processing. In a similar manner, the temperature module 26 may be manually or automatically activated at specific times to heat or cool specified wells 16. For example, the temperature module 26 may automatically increase the temperature of a given well 16 after the logic module 30 detects that a pipette has added a reagent to that well 16. In general, the temperature module 26 is programmable and may carry out a programmed temperature profile including high, low and cycled temperatures and may create temporal and spatial temperature gradients.

As another example, various embodiments may compute reaction rates by means of time of reaction data and data from the imaging apparatus 28. This feature is especially useful for rapid reactions. Still another use of the imaging apparatus 28 may be as a confirmation of the well penetration data from the detectors 20.

Of course, the temperature module 26 and imaging apparatus 28 may be used in wide variety of additional applications. Accordingly, the specific applications discussed above are mentioned for exemplary purposes only and thus, are not intended to limit all aspects of the invention.

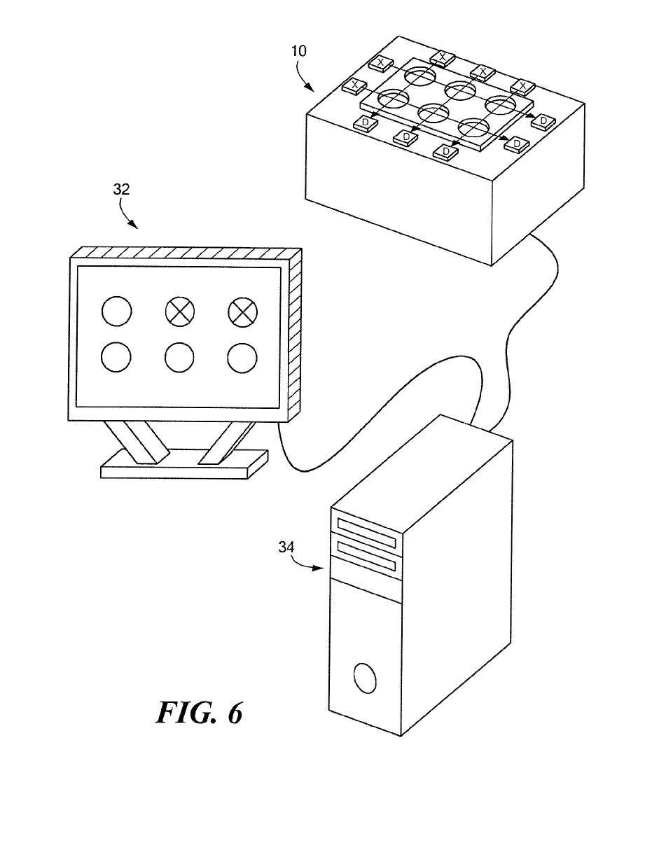

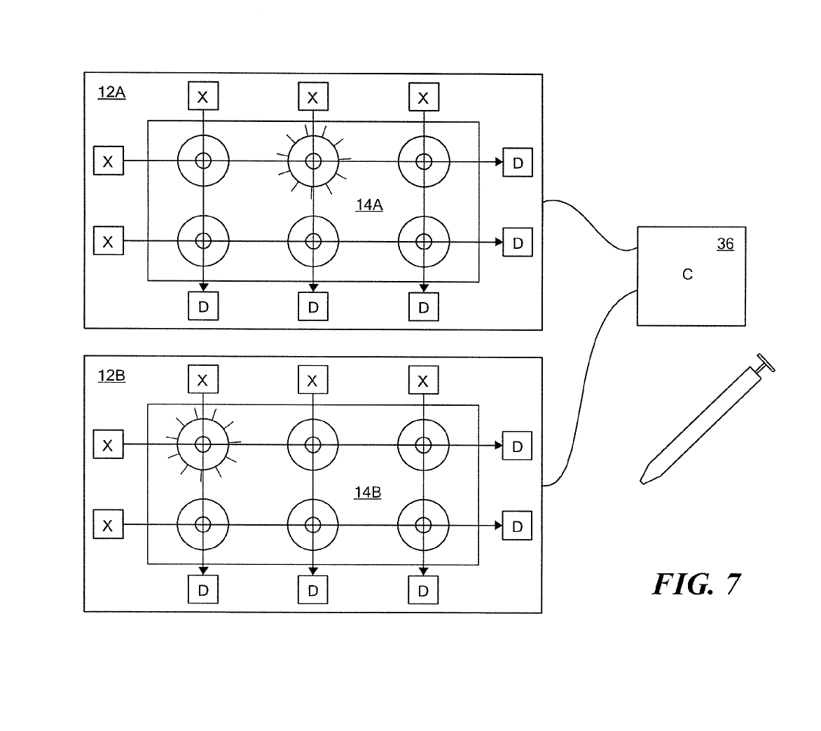

As noted above, some embodiments use an external display, such as liquid crystal display device, a cathode ray tube display device, and/or touch sensitive screen, as a user interface. Such embodiments also may use the external display in addition to, or instead of, the lights illuminating each well 16. FIG. 6 schematically shows such an embodiment. In particular, the embodiment in FIG. 6 shows the system 10 of FIG. 1 connected to a liquid crystal display device 32 and a computer system 34. Accordingly, the liquid crystal display device 32 may implement a user interface, and highlight specific wells 16. As shown by example, the system 10 shown in FIG. 7 is processing a set that includes at least the top center and top right wells 16.

A display device, such as the liquid crystal display device 32 of FIG. 6, may be positioned in a support underneath a clear microliter plate and thus, serve the same function as the visible light elements 31. Of course, placing light elements 31 (e.g., light emitting diodes) or a liquid crystal display device 32 underneath the microplate 14 is of little use if the microliter plate 14 is opaque, as is commonly the case when measuring fluorogenic reactions. In this case, some embodiments position the light elements 31 in-line with each column or row to indicate which wells of the microliter plate 14 should be accessed for liquid dispensing and removal.

FIG. 7 shows another embodiment of the invention using a plurality of microliter plates 14. Specifically, the embodiment shown in FIG. 7 has two support members 12A and 12B that each support a microliter plate 14A and 14B. Of course, various other embodiments can be used with two or more support members 12A and 12B. To coordinate their functionality, the support members 12A and 12B are connected to an external control device 36, such as a computer. In this application, the user may transfer fluid from wells 16 on one microliter plate 14A or 14B to wells 16 on the other microliter plate 14A or 14B. For example, the top center well 16 is illuminated on the top plate 14A of FIG. 7, while the top left well 16 is illuminated on the bottom plate 14B of FIG. 7. Accordingly, a technician may use a pipette to transfer fluid from the top center well 16 in the top microliter plate 14A to the top left well 16 in the bottom microliter plate 14B. In a manner similar to the process of FIG. 3, the light element 31 in the top tray may be turned off after fluid is withdrawn from it. In a corresponding manner, the light element 31 in the bottom tray may be turned off after fluid is added to it.

Some embodiments of the invention feature a “training mode” for generating computerized protocol scripts. A protocol script includes a series of instructions used by a computer to actuate visual indicia that guides a user to specific wells 16 for fluid removal and addition. The protocol script also may contain instructions for the computer to display instructive text to the user in real-time, and may automatically control the volume settings of a liquid dispensing instrument. Protocol scripts may be saved as a computer file and shared with other users. For example, protocol scripts may be supplied on computer media, along with reagent kits, downloadable via the Internet, attached to emails, or archived on a website and referenced in scientific publications.

Among other things, various embodiments of the invention also may be used with multi-channel pipettes for parallel liquid handling operations throughout a row or column of a microplate (e.g., the Gilson Pipetman® Ultra Multichannel for Gilson, Inc., Middleton, Wis.). Handheld, electronically actuated pipettes (e.g., the Rainin EDP-Plus™, Oakland, Calif.) also should operate with the system 10. A greater degree of data logging for an experimental procedure should be obtained using an improved handheld electronic pipette having the capability of recording and transmitting its records of the times of, and volume settings for, liquid-dispensing events. This data could be transmitted via a built-in wireless transmitter, via a cable, or recorded in an on-board memory for later recovery. In this way, additional confirmation of correct experimental procedures may be obtained, and volume information may be automatically programmed in the “training” mode. Additionally, a protocol script may automatically adjust the volume settings of the pipette at different stages of the experiment based on the pattern of well penetration data.

Various embodiments facilitate preparation of training scripts. For example, the system may be set to a programming mode that enables a user to manually perform a set of steps with regard to one or more microliter plate 14s. The diodes 18 and detectors 20 detect and record the sequence of well accesses on some storage medium. A computer program thus uses these accesses as the basis for a program that leads a subsequent user through a procedure, such as that discussed above with regard to FIG. 3. Such a process should significantly simplify programming certain protocols.

Scripts may also be associated with a reagent kit. By using bar codes, 2-dimensional bag codes, RFID tags, or other machine readable media (including media readable by a human), a reagent kit may identify and incorporate a protocol script for use with the system 10. For example, scanning of a bar-code on a reagent kit box or instruction sheet may provide an indentification code that will allow a computer to download an associated protocol from a magnetic media, optical media, or network. Alternately, the protocol may be stored on magnetic media such as a flash memory that is shipped with the reagent kit. Or, the kit may include a piece of paper with an encoded script that may be read with a scanner associate with system 10. In yet another example, a system 10 may be programmed with a script for performing a particular reaction and shipped as part of the reagent kit for that reaction. A script identifier may also be affixed to one or more microtiter-plates that are shipped with the reagent kit.

Scripts may incorporate features designed to increase user safety or environmental awareness. For example, warning messages may be displayed on a computer monitor when a step in a protocol is reached that utilizes a toxic or radioactive agent, or that generates a toxic, flammable or explosive product. Specific instructions may be displayed, or audibly announced to the user to advise the user to exercise caution, use proper safety techniques, or perform proper waste-disposal techniques.

Accordingly, various embodiments detect access to a given receptacle 14 of a fluid handling device, thus enabling a wide variety of additional applications. Moreover, it should be noted that discussion of manual use of the discussed embodiments is illustrative and not intended to limit the scope of all embodiments. Accordingly, the processes discussed above may be implemented with automated equipment, such as a robotic system that dispenses or otherwise handles fluids.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus, system and methods (e.g., see the flow chart described above) may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., WIFI, microwave, infrared or other transmission techniques). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

Although the above discussion discloses various exemplary embodiments of the invention, it should be apparent that those skilled in the art can make various modifications that will achieve some of the advantages of the invention without departing from the true scope of the invention. For example, sample handling that is not liquid handling may be detected using embodiments of the invention; for example, solid objects such as well-strips, swabs, pellets, pills, and others could be detected and recorded.

What is claimed is:

1. A laboratory assistant system comprising:
one or more reagents for performing a laboratory procedure, the reagents packaged;
a set of machine readable instructions corresponding to a set of manual reagent-handling steps for executing the procedure;
a computer adapted to accept the instructions, to accept information related to reagent-handling steps previously executed by the experimentalist; and adapted to communicate to the experimentalist information based on the instructions for a step yet to be executed.

2. A system according to claim 1, wherein the procedure is one of a biological, chemical, biochemical, diagnostic and molecular biological procedure.

3. A system according to claim 1, wherein the set of machine readable instructions is obtained from a source selected from the group consisting of a machine readable media, a pointer to instructions available over a network, and a pointer to instructions available on computer media.

4. A system according to claim 1, wherein the information related to steps previously executed by the experimentalist is obtained using least one sensor adapted to detect a threshold proximity of a liquid dispensing device with respect to a given receptacle within a set of receptacles.

5. A system according to claim 4, wherein the threshold proximity is determined by measuring occlusion of a light beam.

6. A system according to claim 4, wherein the threshold proximity is further correlated using an additional parameter.

7. A system according to claim 6, wherein the additional parameter is occlusion of a light beam.

8. A system according to claim 6, wherein the additional parameter is actuation of a liquid dispenser.

9. A system according to claim 4 wherein the sensor transfers a value related to the position of the given receptacle to the computer and the computer records the position value in association with a clock reading indicative of to the time of sensing the threshold proximity.

10. A system according to claim 9, further including an analytical device adapted to measure a property of the given receptacle and use the clock reading associated with the receptacle to determine a one of a reaction rate and an extent of reaction.

11. A system according to claim 10, wherein the analytical device is an optical microplate reader and the receptacles are wells of a microplate.

12. A system according to claim 1 wherein the computer communicates to the experimentalist via a media selected from the group consisting of audible speech, instructions on a display, and microplate well associated visible indicia.

13. A system according to claim 12, wherein the computer communicates a warning.

14. A method for manufacturing a reagent kit, the method comprising:
packaging at least one reagent;
generating a protocol script readable by a computer so as to generate instructions for a plurality of protocol steps for communicating to an experimentalist an instruction for a first protocol step, awaiting detection of a liquid handling action initiated by the experimentalist and communicating to the experimentalist a second instruction for a second protocol step;
associating the protocol script with the reagent; and
shipping the reagent to one of a customer and a distributor.

15. A microplate reader comprising:
a support member for positioning a microplate, the microplate having an array of receptacles;
an array of optical detectors positioned to detect light emanating from the receptacles;
a proximity threshold sensor adapted to detect a threshold proximity of a liquid handling instrument relative to a given receptacle so as to identify the microplate location of the given well;
a computer adapted to associate and store data related to the optical detectors with a sensor signal given receptacle.

16. A microplate reader according to claim 15 further comprising a plurality of sensors.

17. A microplate reader according to claim 15 further comprising at least one optical emitter adapted to emit light so as to excite fluorescent transitions in a sample held within the receptacles.

18. A microplate reader according to claim 15 further including a clock, wherein the computer uses the clock to associate a time with a threshold proximity signal.

19. A microplate reader according to claim 15 further comprising a temperature control system.

20. A microplate reader according to claim 15, wherein the computer uses a protocol script to communicate instructions to a user based on a pattern of threshold proximity signals.
